(19) United States
(12) Patent Application Publication
(10) Pub. No.: US 2018/0357287 A1
(43) Pub. Date: Dec. 13, 2018

(54) HYBRID SOFTWARE-HARDWARE IMPLEMENTATION OF EDIT DISTANCE SEARCH

(71) Applicant: ScaleFlux, Inc., San Jose, CA (US)

(72) Inventors: Yang Liu, Milpitas, CA (US); Longxiao Li, San Jose, CA (US); Tong Zhang, Albany, CA (US); Fei Sun, Irvine, CA (US); Hao Zhong, Los Gatos, CA (US)

(21) Appl. No.: 16/004,090

(22) Filed: Jun. 8, 2018

Related U.S. Application Data
(60) Provisional application No. 62/517,880, filed on Jun. 10, 2017.

(51) Int. Cl. G06F 17/30; G06F 13/42; G06N 5/04

(52) U.S. Cl. CPC G06F 17/30542; G06F 2213/0026; G06N 5/048; G06F 13/4282

(57) ABSTRACT

A hybrid approach for performing edit distance searching used for fuzzy string searches. A system is disclosed that includes an FPGA (field programmable gate array) appliance, having: a data input manager that receives an m-byte input pattern and loads an n-byte substring of the m-byte input pattern into a first set of registers, and streams input strings of searchable data through a second set of registers; an edit distance calculation engine having an array of processing elements (PEs) implemented using FPGAs coupled to the first and second set of registers, wherein the array of PEs calculate an edit distance for each input string of searchable data relative to n-byte substring; and an output manager that identifies matching input strings having an edit distance less than a threshold, and forwards matching input strings to a CPU for software-based edit distance processing relative to the m-byte input pattern.

### PRIORITY CLAIM

This application claims priority to co-pending provisional application entitled, HYBRID SOFTWARE-HARDWARE IMPLEMENTATION OF EDIT DISTANCE SEARCH, Ser. No. 62/517,880, filed on Jun. 10, 2017, the contents of which are hereby incorporated by reference.

### TECHNICAL FIELD

The present invention relates to the field of data searching, and particularly to improving efficiency and throughput of edit distance searching.

### BACKGROUND

Fuzzy string searching (also referred to as approximate string searching) plays an increasingly important role in modern big data era. Fuzzy string searching aims to find strings that approximately match a given pattern. Different metrics can be used to quantify the proximity between two strings, among which the edit distance (or levenshtein distance) is the most widely used metric. Edit distance between two strings is the minimum number of single-character edits (insertions, deletions or substitutions) required to change one string into the other. Calculation of the edit distance is however very computation intensive, i.e., given two strings with the length of m and n, the computational complexity for an edit distance calculation is O(m·n).

In general, given the search pattern p and the edit distance d, the objective of a fuzzy string search is to find all the strings whose edit distance from the search pattern p is no more than d. The most straightforward approach is to directly calculate the edit distance between p and all the strings in a brute-force manner, which is however subject to very high computational complexity. There are two options to reduce the computational complexity. In a first approach, one could pre-process all the strings to build indexed data structures (e.g., suffix trees), which could significantly reduce the fuzzy search computational complexity. However, the pre-processing stage also tends to have very high computational complexity. Hence this option is suitable only for scenarios where the same content will be searched for many times with different search patterns.

In a second approach, one could employ a two-stage search process to reduce the overall search computational complexity: The first stage carries out simple exact matching to filter out most strings that are guaranteed not to be the matched strings, and the second stage carries out edit distance calculations on what are left by the first stage. This method has been used in the well-known open-source fuzzy search software tool called agrep. The efficiency of this method however quickly degrades as the edit distance d increases. As a result, conventional CPU-based edit distance searching can only work well for relatively small values of d (e.g., 2 or 3).

### SUMMARY

Accordingly, embodiments of the present disclosure are directed to systems and methods for improving the efficiency and throughput in the realization of edit distance searching. Aspects of this invention aim to improve the edit distance search throughput for large value of d (e.g., 6 and above) by leveraging hybrid CPU/FPGA computing platforms.

A first aspect provides a hybrid system for performing fuzzy string searches, comprising: an FPGA (field programmable gate array) appliance, having: a data input manager that receives an m-byte input pattern and loads an n-byte substring of the m-byte input pattern into a first set of registers, and streams input strings of searchable data through a second set of registers; an edit distance calculation engine having an array of processing elements (PEs) implemented using FPGAs coupled to the first and second set of registers, wherein the array of PEs calculate an edit distance for each input string of searchable data relative to n-byte substring; and an output manager that identifies matching input strings having an edit distance less than a threshold, and forwards matching input strings to a CPU for software-based edit distance processing relative to the m-byte input pattern.

A second aspect provides a method for performing fuzzy string searches, comprising: receiving at an FPGA (field programmable gate array) appliance an m-byte input pattern to be search for, and loading an n-byte substring of the m-byte input pattern into a first set of registers; streaming input strings of searchable data through a second set of registers; calculating an edit distance for each input string of searchable data relative to the n-byte substring using an edit distance calculation engine having an array of processing elements (PEs) implemented using FPGAs coupled to the first and second set of registers; and identifying matching input strings having an edit distance less than a threshold, and forwarding matching input strings to a CPU for software-based edit distance processing relative to the m-byte input pattern.

A third aspect provides an FPGA (field programmable gate array) appliance for performing fuzzy string searches, comprising: a data input manager that loads an n-byte input pattern into a first set of registers, and streams input strings of searchable data through a second set of registers; an edit distance calculation engine having an array of processing elements (PEs) implemented using FPGAs coupled to the first and second set of registers, wherein the array of PEs calculate an edit distance for each input string of searchable data relative to n-byte input pattern, wherein the edit distance calculation engine is implemented with a parallel architecture that utilizes an array of n by (n+k+t) PEs, wherein n is a number of bytes that can be stored in the first set of registers, k is a maximum edit distance and t is a parallelism factor, and wherein each of the second set of registers are segmented such that each segment is configure to hold t bytes; and an output manager that identifies matching input strings having an edit distance less than a threshold.

### BRIEF DESCRIPTION OF THE DRAWINGS

The numerous advantages of the present invention may be better understood by those skilled in the art by reference to the accompanying figures in which:

FIG. 1 depicts a storage infrastructure according to embodiments.

FIG. 2 depicts an edit distance calculation data flow diagram.

FIG. 3 depicts a parallel hardware implementation architecture of an edit distance calculation engine.

FIG. 4 depicts an architecture of a fully parallel edit distance calculation engine with a higher throughput.

FIG. 5 depicts a two-stage hybrid CPU/FPGA edit distance search system.

FIG. 6 depicts an illustration of possible substrings of a received input pattern.

FIG. 7 depicts an operational flow diagram of a learning system to select substrings.

### DETAILED DESCRIPTION

Reference will now be made in detail to the presently preferred embodiments of the invention, examples of which are illustrated in the accompanying drawings.

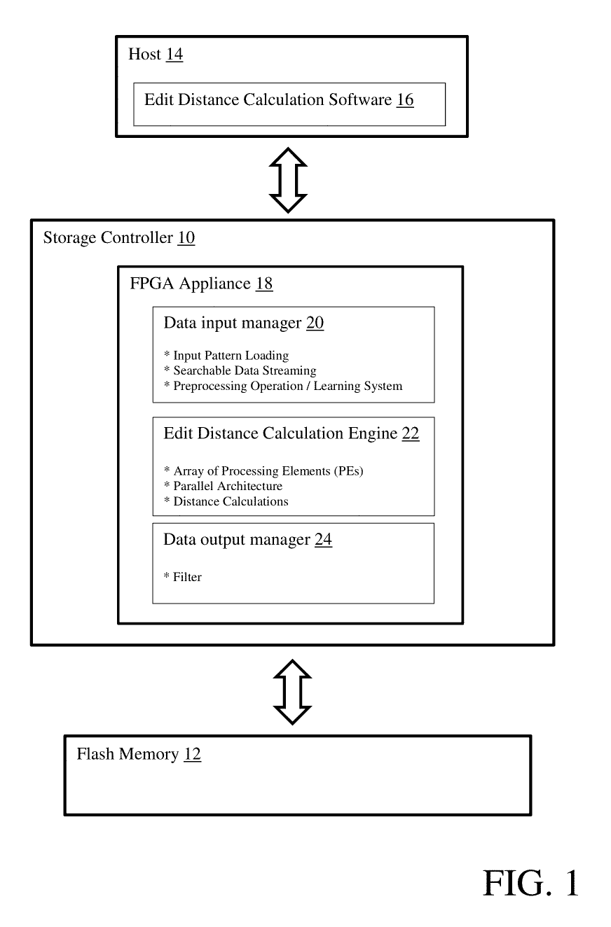

Shown in FIG. 1 is a storage infrastructure that includes an edit distance calculation system 22 implemented in a hardware-based FPGA appliance 18 e.g., using field programmable gate arrays (FPGAs), for performing edit distance calculations. In this illustrative embodiment, the FPGA appliance 18 is integrated into a storage controller 10 that manages data stored in flash memory 12 based on commands from a host (i.e., CPU) 14. In other embodiments, the FPGA device 18 may be integrated into a network device or be implemented as a standalone device or card connected to a computing infrastructure via an interface such as PCIe.

FPGA appliance 18 generally comprises a data input manager 20 that receives and loads a pattern to be searched for (i.e., an input pattern) into a first set of registers in the edit distance calculation engine 22 and receives and streams the data to be searched among (i.e., searchable data) into a second set of registers in the edit distance calculation engine 22. During each clock cycle, a new byte of searchable data is loaded into the right most register, and data from the other registers are shifted left. Data from the left-most register is removed. In this manner, a new string can be searched during each clock cycle. Searchable data may come from flash memory 12 or from another source, e.g., storage devices in a data center (not shown). Edit distance calculation engine 22 includes an array of hardware processing elements (PEs) arranged in a parallel architecture to generate edit distance calculations for the stream of inputted searchable data. Data output manager 24 receives the distance calculations and, e.g., filters them based on a predetermined threshold to identify matches.

As described in further detail below, FPGA appliance 18 may be utilized as a preprocessing operation to search for a substring (e.g., the first n bytes) of an m-byte input pattern. Searchable input strings that result in a match by the preprocessing operation can then be fully evaluated against the full m-byte input pattern by edit distance calculation software 16 on the host 14. A learning system may further be utilized to select the optimal portion of the m-byte input pattern to be used by the edit distance calculation engine 22 during the preprocessing operation.

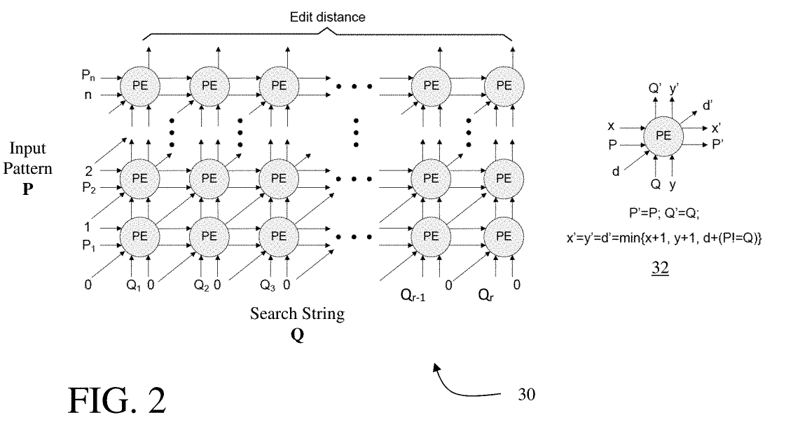

Calculation of edit distance can be formulated as a recursive computation through dynamic programming. This naturally matches to a two-dimensional data flow diagram, as illustrated in FIG. 2. All the PEs in the two-dimensional flow diagram have the same function 32. The input pattern P contains n bytes, each byte is input to one PE, and the to-be-searched string Q contains r bytes, and each byte is input to one PE. When using CPUs to calculate edit distance, the CPU can only carry out the operation for one PE at one time. Hence, to finish the edit distance calculation for each Q, CPU-based realization has a latency proportional to r·n.

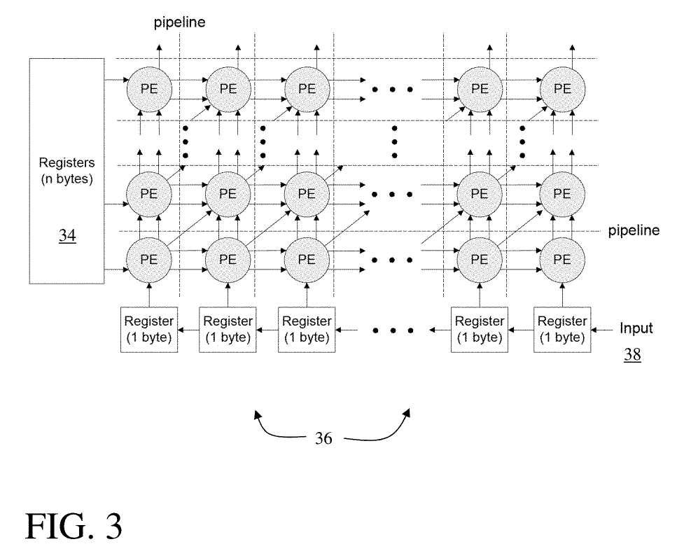

FIG. 3 illustrates a parallel architecture of an edit distance calculation engine 22 implementation for edit distance calculations in which a first set of registers 34 holds the n-byte input pattern, and the search data is streamed (i.e., clocked right to left) into a second set of registers 36 via input 38. Because of their inherent support of high computational parallelism, FPGA devices are utilized herein to significantly improve the throughput of edit distance calculation. All the PEs are physically mapped to FPGAs, and the data flow between adjacent PEs is fully pipelined in order to maximize the clock frequency. Given an input pattern length of n and maximum edit distance of k, the fully parallel FPGA-based edit distance calculation engine 22 contains an array of n by (n+k) PEs, as illustrated in FIG. 3. The (n+k) registers 36 on the bottom hold the current (n+k)-byte string to be search against the n-byte pattern being held in the n registers 34 on the left. The to-be-searched content is streamed, i.e., byte-by-byte input to the (n+k) registers 36, one byte per clock cycle. If f_{clock} denotes the FPGA clock frequency, the fully parallel edit distance calculation engine can achieve a throughput of f_{clock} bytes per second.

Note that the straightforward implementation of FPGA-based edit distance calculation as illustrated in FIG. 3 is subject to two issues. The first issue involves low throughput. Because the clock frequency f_{clock} of FPGA devices tend to be one order of magnitude lower than that of CPU, it is highly desirable to further improve the throughput of each FPGA-based edit distance calculation engine 22. The following embodiment provides a technique that can significantly improve the throughput.

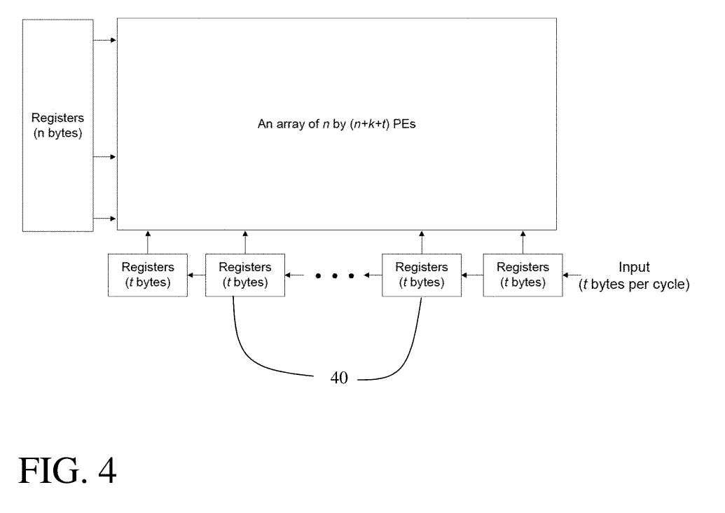

As shown in FIG. 4, an improved parallel arrangement introduces a parallelism factor t and implements an array of n by (n+k+t) PEs. The searchable data content is input to the (n+k+t) registers at a rate of t bytes per clock cycle. In FIG. 4, the total (n+k+t) registers are partitioned into a number of segments 40, and each segment 40 holds t bytes. Over each clock cycle, the content of one segment is moved to the next segment. By increasing the hardware complexity by a ratio of (n+k+t)/(n+k), this improved design can achieve t×higher throughput without any search accuracy degradation.

A second issue of the system shown in FIG. 3 is the lack of flexibility. Suppose the FPGA-based edit distance calculation engine 22 contains an array of n by (n+k) PEs. If the calculation relies solely on the engine 22 to carry out the edit distance calculation, the input pattern length is limited by n, which could be a stringent constraint. For example, suppose n=16, but the input pattern was a string of 20 bytes, the engine 22 could not handle it. Although implementing an engine 22 with a large value of n (e.g., 32 or 48) could relieve the constraint, such an implementation suffers from a very high implementation cost. Meanwhile, since the length of input pattern could significantly vary in practice, implementing an edit distance calculation engine 22 with a very large value of n could result in poor on-average hardware utilization efficiency. For example, suppose n=32, but the typical input search pattern is a string of only 10 bytes, then there is a significant cost attributable to unused hardware. Hence, the FPGA-only edit distance calculation is fundamentally subject to a trade-off between flexibility and hardware utilization efficiency. To better embrace this trade-off, the following embodiment provides a hybrid CPU-FPGA implementation approach.

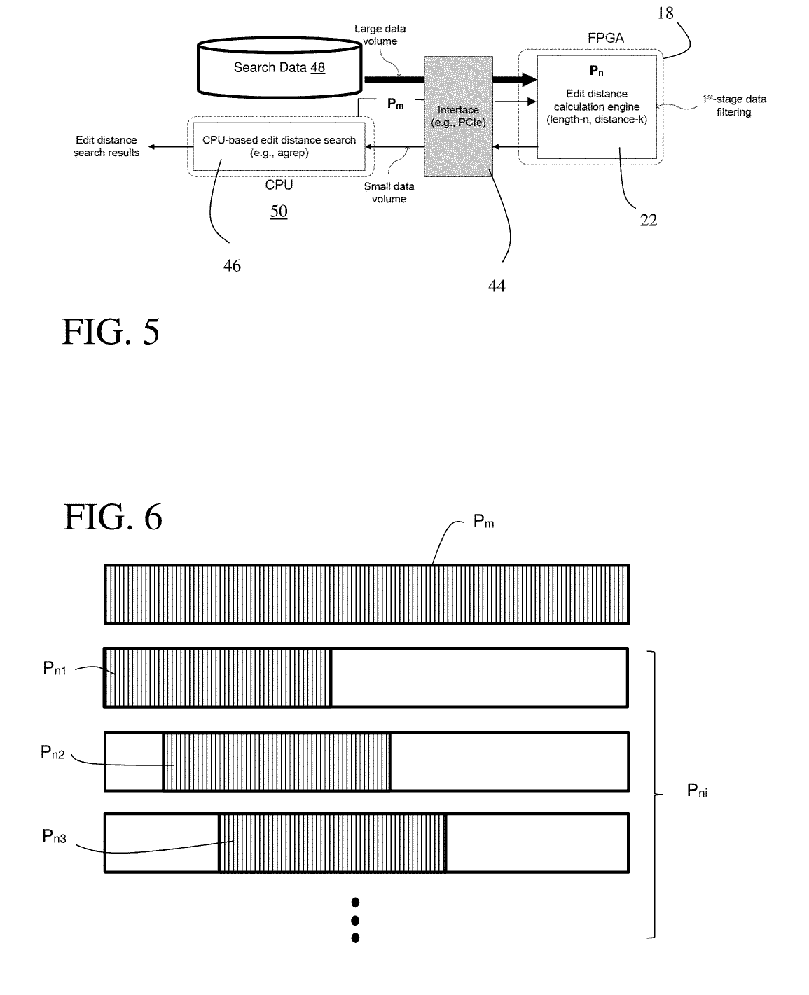

An example of a hybrid embodiment is shown in FIG. 5, in which the FPGA-based edit distance calculation engine 22 provides a first stage of data filtering and a CPU-based edit distance search 46 (implemented in software) provides a second stage. In this illustrative embodiment, a PCIe interface 44 is utilized to provide access to the FPGA appliance 18, CPU 50, and the searchable data 48. Initially, a search pattern Pₘ is provided by the CPU 50 to the FPGA device 18, which then performs a first stage fuzzy string search using a substring of the original search pattern Pₘ on the large volume of searchable data 48. The resulting matching strings, which comprise a relatively small amount of data, are forwarded to the CPU 50 where a software-based edit distance search 46 is implemented (second stage) using the full m-byte input pattern to generate edit distance search results.

The FPGA-based edit distance calculation engine 18 contains an array of n by (n+r) PEs. To support a fuzzy search against an input pattern with the length of m>n and edit distance of k≤r, a length-n substring (Pₙ) is chosen from the complete length-m input pattern (Pₘ) as the partial search pattern being held in the FPGA appliance 18. The FPGA appliance is configured to receive (r−k)-bytes of search data 48 per clock cycle, i.e., the total (n+r) registers are partitioned into a number of segments, and each segment has (r−k) bytes and during each clock cycle the content in one segment is moved to the next segment. Once the FGPA appliance finds a match, it will send the matched content to the CPU 50 for further processing, where the CPU 50 calculates the edit distance against the full length-m search pattern.

As illustrated in FIG. 5, the hybrid architecture essentially forms a two-stage edit distance search: The edit distance calculation engine 22 operates as a preprocessing element, which filters out all the content that is guaranteed not to contain matched strings, through partial edit distance calculation. Then the CPU 50 carries out the full edit distance calculation on what is left by the FPGA engine 22.

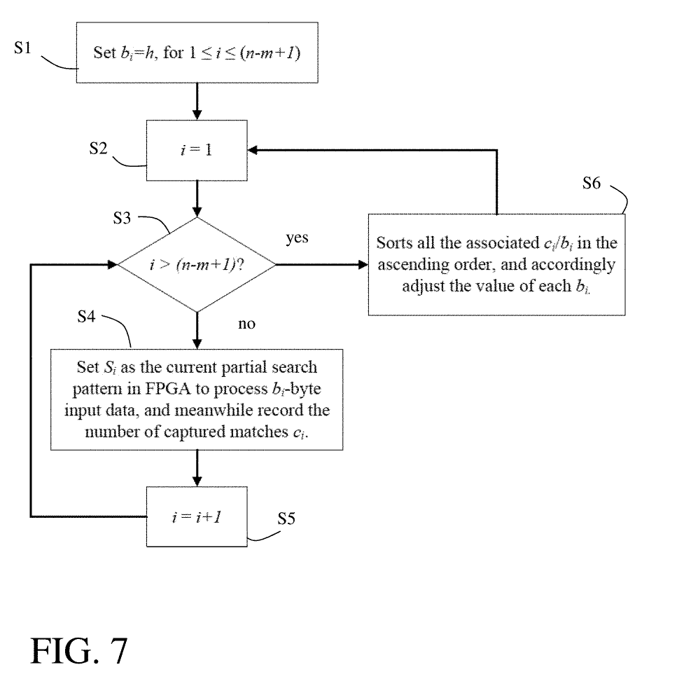

FIGS. 6 and 7 illustrate a learning system that that can be used to further improved the effectiveness of the hybrid approach. As shown in FIG. 6, Pₘ denotes the full length-m search input pattern and each Pₙᵢ denotes the possible length-n partial search patterns (i.e., substrings). Selecting which length-n portion out of Pₘ to form the length-n partial search pattern could noticeably affect the filtering efficiency of the FPGA-based first-stage preprocessing. For a given input pattern Pₘ, the learning system evaluates each option Pₙ₁, Pₙ₁, etc., over a predetermined amount of time or computations to determine the best substring for the input pattern.

FIG. 7 shows an illustrative operational flow diagram of the learning system. Note that there are total (m−n+1) length-n sub-strings of the full length-m search pattern. Let Sᵢ denote the i-th length-n sub-string, where 1≤i≤(m−n+1). Let bᵢ and cᵢ, where 1≤i≤(m−n+1), denote integer variables and all the bᵢ's are initiated as a constant h. The FPGA appliance 18 uses Sᵢ as the search pattern for bᵢ input bytes, and records the number of captured matches cᵢ. Once the FPGA-based engines have used all the (m−n+1) length-n search pattern Sᵢ's, it sorts all the associated cᵢ/bᵢ in the ascending order, and accordingly adjust the value of each bᵢ, i.e., the smaller current cᵢ/bᵢ is, the more we increase the value of bᵢ.

In the example of FIG. 7, bᵢ equals h at S1, and i set to 1 initially at S2. At S3, a determination is made whether i>(m−n+1), i.e., no more possible sub-strings? If no, then at S4, Sᵢ is set as the current sub-string (i.e., partial search pattern) and the number of matches cᵢ is recorded for the b bytes of processing. At S5, when the bᵢ bytes of processing have completed, i is incremented and flow returns to S3. If S3 returns a yes, then the results are sorted and the best sub-string(s) is utilized for the preprocessing stage. The process may be repeated every so often during the search.

It is understood that the FPGA appliance 18 may be implemented in any manner, e.g., as an integrated circuit board or a controller card that includes a processing core, I/O and processing logic. Aspects of the processing logic may be implemented in hardware/software, or a combination thereof. For example, aspects of the processing logic may be implemented using field programmable gate arrays (FPGAs), ASIC devices, or other hardware-oriented system.

Other aspects, such as I/O, may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by hardware and/or computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A hybrid system for performing fuzzy string searches, comprising:
an FPGA (field programmable gate array) appliance, having:
a data input manager that receives an m-byte input pattern and loads an n-byte substring of the m-byte input pattern into a first set of registers, and streams input strings of searchable data through a second set of registers;
an edit distance calculation engine having an array of processing elements (PEs) implemented using FPGAs coupled to the first and second set of registers, wherein the array of PEs calculate an edit distance for each input string of searchable data relative to n-byte substring; and
an output manager that identifies matching input strings having an edit distance less than a threshold, and forwards matching input strings to a CPU for software-based edit distance processing relative to the m-byte input pattern.

2. The hybrid system of claim 1, wherein the FPGA appliance is integrated into a storage controller.

3. The hybrid system of claim 1, wherein the FPGA appliance connects to a data center of searchable data via a PCIe interface.

4. The hybrid system of claim 1, wherein the edit distance calculation engine is implemented with a parallel architecture that utilizes an array of n by (n+k+t) PEs, wherein n is a number of bytes that can be stored in the first set of registers, k is a maximum edit distance and t is a parallelism factor, wherein each of the second set of registers are segmented such that each segment is configure to hold t bytes.

5. The hybrid system of claim 4, wherein the searchable data is input to the second set of registers at t bytes per clock cycle such that over each clock cycle, content of one segment of t bytes is moved to a next segment of t bytes.

6. The hybrid system of claim 1, wherein the n-byte substring of the m-byte input pattern is determined using a learning system.

7. The hybrid system of claim 6, wherein the learning system evaluates different possible substrings during a search to determine an optimal substring.

8. A method for performing fuzzy string searches, comprising:
receiving at an FPGA (field programmable gate array) appliance an m-byte input pattern to be search for, and loading an n-byte substring of the m-byte input pattern into a first set of registers;
streaming input strings of searchable data through a second set of registers;
calculating an edit distance for each input string of searchable data relative to the n-byte substring using an edit distance calculation engine having an array of processing elements (PEs) implemented using FPGAs coupled to the first and second set of registers; and
identifying matching input strings having an edit distance less than a threshold, and forwarding matching input strings to a CPU for software-based edit distance processing relative to the m-byte input pattern.

9. The method of claim 8, wherein the FPGA appliance is integrated into a storage controller.

10. The method of claim 8, wherein the FPGA appliance connects to a data center of searchable data via a PCIe interface.

11. The method of claim 8, wherein the edit distance calculation engine is implemented with a parallel architecture that utilizes an array of n by (n+k+t) PEs, wherein n is a number of bytes that can be stored in the first set of registers, k is a maximum edit distance and t is a parallelism factor, wherein each of the second set of registers are segmented such that each segment is configure to hold t bytes.

12. The method of claim 11, wherein the searchable data is input to the second set of registers at t bytes per clock cycle such that over each clock cycle, content of one segment of t bytes is moved to a next segment of t bytes.

13. The method of claim 8, where the n-byte substring of the m-byte input pattern is determined using a learning system.

14. The method of claim 13, wherein the learning system evaluates different possible substrings during a search to determine an optimal substring.

15. An FPGA (field programmable gate array) appliance for performing fuzzy string searches, comprising:
a data input manager that loads an n-byte input pattern into a first set of registers, and streams input strings of searchable data through a second set of registers;
an edit distance calculation engine having an array of processing elements (PEs) implemented using FPGAs coupled to the first and second set of registers, wherein the array of PEs calculate an edit distance for each input string of searchable data relative to n-byte input pattern, wherein the edit distance calculation engine is implemented with a parallel architecture that utilizes an array of n by (n+k+t) PEs, wherein n is a number of bytes that can be stored in the first set of registers, k is a maximum edit distance and t is a parallelism factor, and wherein each of the second set of registers are segmented such that each segment is configure to hold t bytes; and
an output manager that identifies matching input strings having an edit distance less than a threshold.

16. The FPGA appliance of claim 15, wherein the searchable data is input to the second set of registers at t bytes per clock cycle such that over each clock cycle, content of one segment of t bytes is moved to an adjacent segment of t bytes.

17. The FPGA appliance of claim 15, wherein the n-byte input pattern is a substring of a received m-byte input pattern.

18. The FPGA appliance of claim 17, wherein the m-byte input pattern is determined using a learning system.

19. The FPGA appliance of claim 18, wherein the learning system evaluates different possible substrings during a search to determine an optimal substring.

20. The FPGA appliance of claim 18, wherein the output manager forwards matching input strings to a CPU for software-based edit distance processing relative to the m-byte input pattern.
